(19) United States
(12) Patent Application Publication
(10) Pub. No.: US 2011/0090195 A1
(43) Pub. Date: Apr. 21, 2011

(54) DRIVING DEVICE AND DRIVING METHOD OF PLASMA DISPLAY PANEL, AND PLASMA DISPLAY APPARATUS

(75) Inventors: Takahiko Origuchi, Osaka (JP); Hidehiko Shoji, Osaka (JP)

(73) Assignee: PANASONIC CORPORATION, Osaka (JP)

(21) Appl. No.: 12/866,965

(22) PCT Filed: Feb. 17, 2009
(86) PCT No.: PCT/JP2009/000631

§ 371 Date: Aug. 10, 2010

(30) Foreign Application Priority Data
Feb. 27, 2008 (JP) 2008-045444

(51) Int. Cl. G09G 3/10; G06F 3/038

(52) U.S. Cl. 345/208; 345/41

(57) ABSTRACT

A driving device drives a plasma display panel having a plurality of discharge cells at intersections of a plurality of scan electrodes and a plurality of sustain electrodes with a plurality of data electrodes by a sub-field method. A scan electrode drive circuit applies a first ramp waveform that drops from a first potential to a second potential to the plurality of scan electrodes in a first period in a setup period of a sub-field. A sustain electrode drive circuit applies a second ramp waveform that drops from a fourth potential to a fifth potential to the plurality of sustain electrodes when a potential detection circuit detects that the plurality of scan electrodes attain a third potential that is lower than the first potential and higher than the second potential in the first period.

### TECHNICAL FIELD

The present invention relates to a driving device and a driving method of a plasma display panel, and a plasma display apparatus using the same.

### BACKGROUND ART

An AC surface discharge type panel that is typical as a plasma display panel (hereinafter abbreviated as a “panel”) includes a number of discharge cells between a front plate and a back plate arranged to face each other.

The front plate is constituted by a front glass substrate, a plurality of display electrodes, a dielectric layer and a protective layer. Each display electrode is composed of a pair of scan electrode and sustain electrode. The plurality of display electrodes are formed in parallel with one another on the front glass substrate, and the dielectric layer and the protective layer are formed to cover the display electrodes.

The back plate is constituted by a back glass substrate, a plurality of data electrodes, a dielectric layer, a plurality of barrier ribs and phosphor layers. The plurality of data electrodes are formed in parallel with one another on the back glass substrate, and the dielectric layer is formed to cover the data electrodes. The plurality of barrier ribs are formed in parallel with the data electrodes, respectively, on the dielectric layer, and the phosphor layers of R (red), G (green) and B (blue) are formed on a surface of the dielectric layer and side surfaces of the barrier ribs.

The front plate and the back plate are arranged to face each other such that the display electrodes intersect with the data electrodes in three dimensions, and then sealed. An inside discharge space is filled with a discharge gas. The discharge cells are formed at respective portions at which the display electrodes and the data electrodes face one another.

In the panel having such a configuration, a gas discharge generates ultraviolet rays, which cause phosphors of R, G and B to be excited and to emit light in each of the discharge cells. Accordingly, color display is performed.

A sub-field method is employed as a method of driving the panel (see Patent Document 1, for example). In the sub-field method, one field period is divided into a plurality of sub-fields, and the discharge cells are caused to emit light or not in the respective sub-fields, so that gray scale display is performed. Each of the sub-fields has a setup period, a write period and a sustain period.

In the setup period, a setup pulse is applied to each of the scan electrodes, and a setup discharge is performed in each of the discharge cells. This causes wall charges required for a subsequent write operation to be formed in each of the discharge cells.

In the write period, scan pulses are applied to the scan electrodes in sequence while write pulses corresponding to image signals to be displayed are applied to the data electrodes. This selectively generates write discharges between the scan electrodes and the data electrodes, causing the wall charges to be selectively formed.

In the subsequent sustain period, sustain pulses are applied between the scan electrodes and the sustain electrodes a given number of times corresponding to luminances to be displayed. Accordingly, discharges are selectively induced in the discharge cells in which the wall charges have been formed by the write discharges, causing the discharge cells to emit light.

Here, in the foregoing setup period, respective voltages applied to the scan electrodes, the sustain electrodes and the data electrodes are adjusted in order to generate weak discharges in the discharge cells (see Patent Document 2).

Specifically, a ramp voltage that gradually rises is applied to the scan electrodes in the first half of the setup period (hereinafter referred to as a rise period). This generates the weak discharges between the scan electrodes and the data electrodes and between the sustain electrodes and the data electrodes in the rise period.

A ramp voltage that gradually drops is applied to the scan electrodes in the second half of the setup period (hereinafter referred to as a drop period). This generates the weak discharge between the scan electrodes and the data electrodes and between the sustain electrodes and the data electrodes in the drop period.
[Patent Document 1] JP 2006-18298 A
[Patent Document 2] JP 2003-15599 A

### DISCLOSURE OF THE INVENTION

### Problems to be Solved by the Invention

In the foregoing drop period, a ramp voltage that gradually drops is applied to the sustain electrodes at a given timing, so that the potential difference between the scan electrodes and the sustain electrodes can be temporarily maintained constant to suppress an occurrence of discharges between the scan electrodes and the sustain electrodes. This allows an amount of electric charges generated by discharges between the scan electrodes and the sustain electrodes to be adjusted.

However, a rate of change in the potential of the scan electrodes in the drop period tends to vary. This makes it difficult to accurately adjust the amount of electric charges generated by discharges between the scan electrodes and the sustain electrodes.

An object of the present invention is to provide a driving device and a driving method of a plasma display panel allowing for accurate adjustment of an amount of electric charges generated by discharges between the scan electrodes and the sustain electrodes, and a plasma display apparatus using the same.

### Means for Solving the Problems

(1) According to an aspect of the present invention, a driving device of a plasma display panel that drives a plasma display panel having a plurality of discharge cells at intersections of a plurality of scan electrodes and a plurality of sustain electrodes with a plurality of data electrodes by a sub-field method in which one field includes a plurality of sub-fields includes a scan electrode drive circuit that drives the plurality of scan electrodes, a sustain electrode drive circuit that drives the plurality of sustain electrodes, and a potential detection circuit, wherein the scan electrode drive circuit applies a first ramp waveform that drops from a first potential to a second potential to the plurality of scan electrodes in a first period in a setup period of at least one sub-field of the plurality of sub-fields, the potential detection circuit detects that the plurality of scan electrodes attain a third potential that is lower than the first potential and higher than the second potential in the first period, and the sustain electrode drive circuit applies a second ramp waveform that drops from a fourth potential to a fifth potential to the plurality of sustain electrodes in response to detection of the third potential by the potential detection circuit.

In the driving device, the first ramp waveform that drops from the first potential to the second potential is applied to the plurality of scan electrodes by the scan electrode drive circuit in the first period in the setup period of the at least one sub-field of the plurality of sub-fields. This generates setup discharges between the plurality of scan electrodes and the plurality of sustain electrodes. As a result, wall charges on the plurality of scan electrodes and the plurality of sustain electrodes are adjusted to be suitable for write discharges in a write period.

When the potential detection circuit detects that the plurality of scan electrodes attain the third potential that is lower than the first potential and higher than the second potential, the second ramp waveform that drops from the fourth potential to the fifth potential is applied to the plurality of sustain electrodes by the sustain electrode drive circuit.

The second ramp waveform is applied to the plurality of sustain electrodes, thereby suppressing an increase in a potential difference between the plurality of scan electrodes and the plurality of sustain electrodes. This suppresses an occurrence of discharges between the plurality of scan electrodes and the plurality of sustain electrodes.

In this manner, the second ramp waveform is applied to the plurality of sustain electrodes at a timing where the potential detection circuit detects that the potential of the plurality of scan electrodes attains the third potential. This allows an amount of electric charges generated by discharges between the plurality of scan electrodes and the plurality of sustain electrodes to be accurately adjusted even though the slope of the first ramp waveform (a rate of change in the potential) varies. As a result, malfunctions such as erroneous discharges can be reliably prevented from occurring in the write period and a sustain period of the sub-field.

(2) The sustain electrode drive circuit may bring the plurality of sustain electrodes into a floating state in response to the detection of the third potential by the potential detection circuit.

When the plurality of sustain electrodes are in the floating state, the potential of the plurality of sustain electrodes changes according to change in the potential of the plurality of scan electrodes due to capacitive coupling. Thus, the potential of the plurality of the sustain electrodes changes according to the first ramp waveform applied to the plurality of scan electrodes. Accordingly, the second ramp waveform can be applied to the plurality of sustain electrodes with a simple circuit configuration. As a result, rising cost is avoided.

(3) The potential detection circuit may generate a switching signal in a period, in which a potential of the plurality of scan electrodes drops from the third potential to the second potential, in the first period, and the sustain electrode drive circuit may apply the second ramp waveform to the plurality of sustain electrodes in the period in which the switching signal is maintained.

In this case, an occurrence of discharges between the plurality of scan electrodes and the plurality of sustain electrodes can be reliably suppressed in the period where the potential of the plurality of scan electrodes drops from the third potential to the second potential. This allows the amount of electric charges generated by discharges between the plurality of scan electrodes and the plurality of sustain electrodes to be more accurately adjusted.

(4) The sustain electrode drive circuit may hold the plurality of sustain electrodes at the fourth potential in a write period of the at least one sub-field of the plurality of sub-fields.

In this case, the plurality of sustain electrodes can be held at the common fourth potential in a period before application of the second ramp waveform in the setup period, and in the write period. Therefore, the configuration of the sustain electrode drive circuit can be simplified as compared with a case where the plurality of sustain electrodes are held at different potentials in these periods. This allows for cost reduction.

(5) According to another aspect of the present invention, a driving method of a plasma display panel that drives a plasma display panel having a plurality of discharge cells at intersections of a plurality of scan electrodes and a plurality of sustain electrodes with a plurality of data electrodes by a sub-field method in which one field includes a plurality of sub-fields, comprising the steps of applying a first ramp waveform that drops from a first potential to a second potential to the plurality of scan electrodes in a first period in a setup period of at least one sub-field of the plurality of sub-fields, detecting that the plurality of scan electrodes attain a third potential that is lower than the first potential and higher than the second potential in the first period, and applying a second ramp waveform that drops from a fourth potential to a fifth potential to the plurality of sustain electrodes in response to detection of the third potential.

In the driving method, the first ramp waveform that drops from the first potential to the second potential is applied to the plurality of scan electrodes in the first period in the setup period of the at least one sub-field of the plurality of sub-fields. This generates setup discharges between the plurality of scan electrodes and the plurality of sustain electrodes. As a result, wall charges on the plurality of scan electrodes and the plurality of sustain electrodes are adjusted to be suitable for write discharges in a write period.

When it is detected that the plurality of scan electrodes attain the third potential that is lower than the first potential and higher than the second potential, the second ramp waveform that drops from the fourth potential to the fifth potential is applied to the plurality of sustain electrodes.

The second ramp waveform is applied to the plurality of sustain electrodes, thereby suppressing an increase in a potential difference between the plurality of scan electrodes and the plurality of sustain electrodes. This suppresses an occurrence of discharges between the plurality of scan electrodes and the plurality of sustain electrodes.

In this manner, the second ramp waveform is applied to the plurality of sustain electrodes at a timing where it is detected that the potential of the plurality of scan electrodes attains the third potential. This allows an amount of electric charges generated by discharges between the plurality of scan electrodes and the plurality of sustain electrodes to be accurately adjusted even though the slope of the first ramp waveform (a rate of change in the potential) varies. As a result, malfunctions such as erroneous discharges can be reliably prevented from occurring in the write period and a sustain period of the sub-field.

(6) According to still another aspect of the present invention, a plasma display apparatus includes a plasma display panel having a plurality of discharge cells at intersections of a plurality of scan electrodes and a plurality of sustain electrodes with a plurality of data electrodes, and a driving device that drives the plasma display panel by a sub-field method in which one field includes a plurality of sub-fields, wherein the driving device includes a scan electrode drive circuit that drives the plurality of scan electrodes, a sustain electrode drive circuit that drives the plurality of sustain electrodes, and a potential detection circuit, the scan electrode drive circuit applies a first ramp waveform that drops from a first potential to a second potential to the plurality of scan electrodes in a first period in a setup period of at least one sub-field of the plurality of sub-fields, the potential detection circuit detects that the plurality of scan electrodes attain a third potential that is lower than the first potential and higher than the second potential in the first period, and the sustain electrode drive circuit applies a second ramp waveform that drops from a fourth potential to a fifth potential to the plurality of sustain electrodes in response to detection of the third potential by the potential detection circuit.

In the plasma display apparatus, the driving device drives the plasma display panel by the sub-field method in which one field includes the plurality of sub-fields.

The first ramp waveform that drops from the first potential to the second potential is applied to the plurality of scan electrodes by the scan electrode drive circuit in the first period in the setup period of the at least one sub-field of the plurality of sub-fields. This generates setup discharges between the plurality of scan electrodes and the plurality of sustain electrodes. As a result, wall charges on the plurality of scan electrodes and the plurality of sustain electrodes are adjusted to be suitable for write discharges in a write period.

When the potential detection circuit detects that the plurality of scan electrodes attain the third potential that is lower than the first potential and higher than the second potential, the second ramp waveform that drops from the fourth potential to the fifth potential is applied to the plurality of sustain electrodes by the sustain electrode drive circuit.

The second ramp waveform is applied to the plurality of sustain electrodes, thereby suppressing an increase in a potential difference between the plurality of scan electrodes and the plurality of sustain electrodes. This suppresses an occurrence of discharges between the plurality of scan electrodes and the plurality of sustain electrodes.

In this manner, the second ramp waveform is applied to the plurality of sustain electrodes at a timing where the potential detection circuit detects that the potential of the plurality of scan electrodes attains the third potential. This allows an amount of electric charges generated by discharges between the plurality of scan electrodes and the plurality of sustain electrodes to be accurately adjusted even though the slope of the first ramp waveform (a rate of change in the potential) varies. As a result, malfunctions such as erroneous discharges can be reliably prevented from occurring in the write period and a sustain period of the sub-field.

### EFFECTS OF THE INVENTION

According to the present invention, the amount of electric charges generated by discharges between the plurality of scan electrodes and the plurality of sustain electrodes can be accurately adjusted even though the rate of change in the potential of the plurality of scan electrodes varies. As a result, malfunctions such as erroneous discharges can be reliably prevented from occurring in the write period and the sustain period of the sub-field.

### BRIEF DESCRIPTION OF THE DRAWINGS

FIG. 1 is an exploded perspective view showing part of a plasma display panel in a plasma display apparatus.

FIG. 2 is a diagram showing an arrangement of electrodes of the panel.

FIG. 3 is a block diagram of circuits in the plasma display apparatus.

FIG. 4 is a driving waveform diagram in a sub-field configuration of the plasma display apparatus of FIG. 3.

FIG. 5 is a circuit diagram showing the configuration of a scan electrode drive circuit.

FIG. 6 is a diagram showing correspondences among respective logic of control signals and states of scan ICs.

FIG. 7 is a timing chart of control signals applied to the scan electrode drive circuit.

FIG. 8 is a timing chart of the control signals applied to the scan electrode drive circuit.

FIG. 9 is a circuit diagram showing the configuration of a sustain electrode drive circuit.

FIG. 10 is a timing chart of control signals applied to the sustain electrode drive circuit.

FIG. 11 is a timing chart of the control signals applied to the sustain electrode drive circuit.

FIG. 12 is a circuit diagram specifically showing the configurations of a comparison circuit, a potential detection circuit and peripheral portions thereof.

FIG. 13 is a block diagram of circuits showing another configuration of the plasma display apparatus.

### BEST MODE FOR CARRYING OUT THE INVENTION

The embodiments of the present invention will be described in detail referring to the drawings. The embodiments below describe a driving device and a driving method of a plasma display panel, and a plasma display apparatus.

### (1) Configuration of Panel

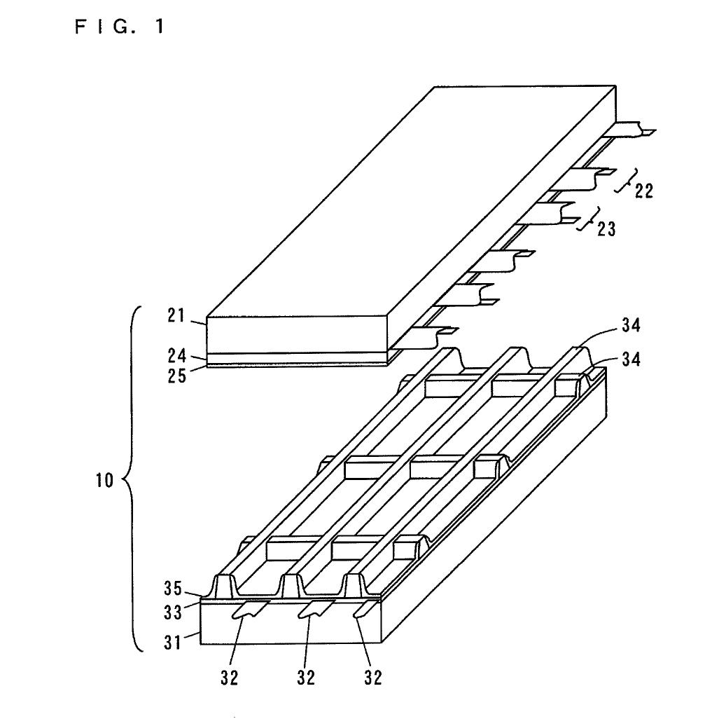

FIG. 1 is an exploded perspective view showing part of a plasma display panel in a plasma display apparatus according to the present embodiment.

The plasma display panel (hereinafter abbreviated as the panel) 10 includes a front substrate 21 and a back substrate 31 that are made of glass and arranged to face each other. A discharge space is formed between the front substrate 21 and the back substrate 31. A plurality of pairs of scan electrodes 22 and sustain electrodes 23 are formed in parallel with one another on the front substrate 21. Each pair of scan electrode 22 and sustain electrode 23 constitutes a display electrode. A dielectric layer 24 is formed to cover the scan electrodes 22 and the sustain electrodes 23, and a protective layer 25 is formed on the dielectric layer 24.

A plurality of data electrodes 32 covered with an insulator layer 33 are provided on the back substrate 31, and barrier ribs 34 are provided in a shape of a number sign on the insulator layer 33. Phosphor layers 35 are provided on a surface of the insulator layer 33 and side surfaces of the barrier ribs 34. Then, the front substrate 21 and the back substrate 31 are arranged to face each other such that the plurality of pairs of scan electrodes 22 and sustain electrodes 23 vertically intersect with the plurality of data electrodes 32, and the discharge space is formed between the front substrate 21 and the back substrate 31. The discharge space is filled with a mixed gas of neon and xenon, for example, as a discharge gas. The configuration of the panel is not limited to the configuration described in the foregoing. A configuration including the barrier ribs in a striped shape may be employed, for example.

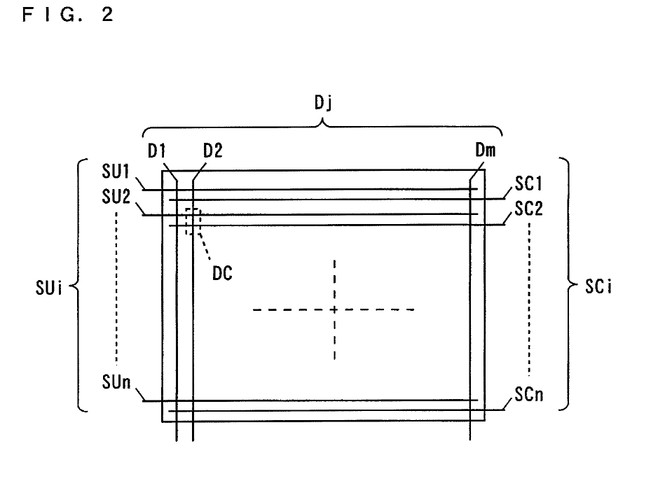

FIG. 2 is a diagram showing an arrangement of electrodes of the panel of the present embodiment. N scan electrodes SC1 to SCn (the scan electrodes 22 of FIG. 1) and n sustain electrodes SU1 to SUn (the sustain electrodes 23 of FIG. 1) are arranged along a row direction, and m data electrodes D1 to Dm (the data electrodes 32 of FIG. 1) are arranged along a column direction. Each of n and m is a natural number of not less than two. Then, a discharge cell DC is formed at an intersection of a pair of scan electrode SCi (i=1 to n) and sustain electrode SUi (i=1 to n) with one data electrode Dj (j=1 to m). Accordingly, m×n discharge cells are formed in the discharge space.

### (2) Configuration of the Plasma Display Apparatus

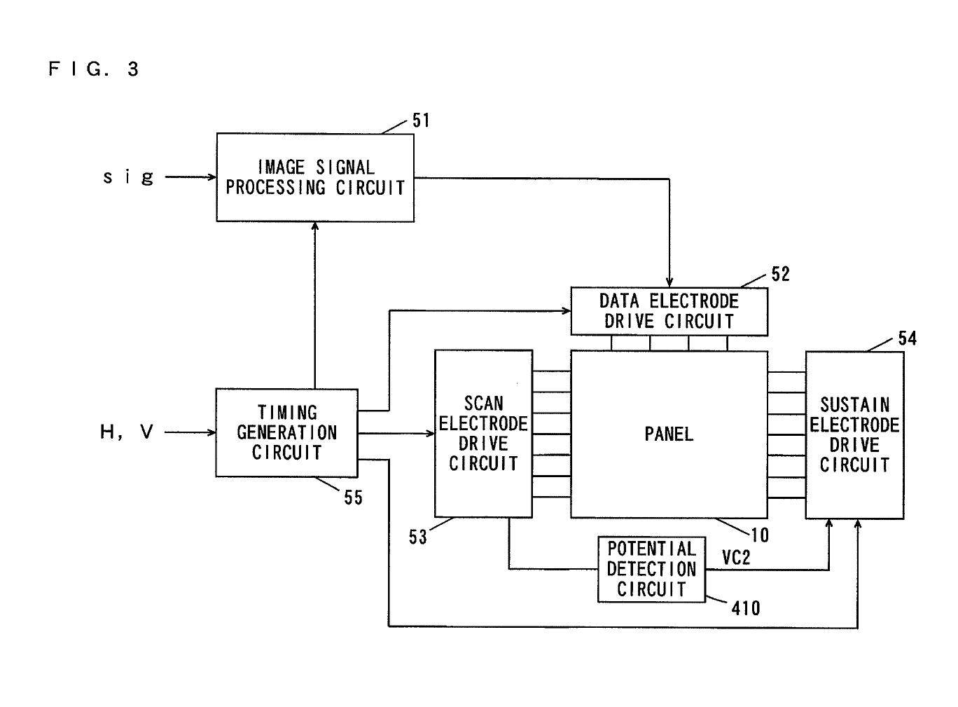

FIG. 3 is a block diagram of circuits in the plasma display apparatus according to the present embodiment.

The plasma display apparatus includes the panel 10, an image signal processing circuit 51, a data electrode drive circuit 52, a scan electrode drive circuit 53, a sustain electrode drive circuit 54, a timing generation circuit 55, a potential detection circuit 410, and a power supply circuit (not shown).

The image signal processing circuit 51 converts an image signal sig into image data corresponding to the number of pixels of the panel 10, divides the image data on each pixel into a plurality of bits corresponding to a plurality of sub-fields, and outputs them to the data electrode drive circuit 52.

The data electrode drive circuit 52 converts the image data for each sub-field into signals corresponding to the data electrodes D1 to Dm, respectively, and drives the data electrodes D1 to Dm based on the respective signals.

The timing generation circuit 55 generates timing signals based on a horizontal synchronizing signal H and a vertical synchronizing signal V, and supplies the timing signals to each of the drive circuit blocks (the image signal processing circuit 51, the data electrode drive circuit 52, the scan electrode drive circuit 53 and the sustain electrode drive circuit 54).

The scan electrode drive circuit 53 supplies driving waveforms to the scan electrodes SC1 to SCn based on the timing signals, and the sustain electrode drive circuit 54 supplies driving waveforms to the sustain electrodes SU1 to SUn based on the timing signals. The potential detection circuit 410 detects the potential of the scan electrodes SC1 to SCn from the scan electrode drive circuit 53, and applies a potential switching signal VC2 to the sustain electrode drive circuit 54 depending on a result of the detection.

### (3) Sub-Field Configuration

Next, a sub-field configuration is explained. In a sub-field method, one field ( 1/60 seconds=16.67 msec) is divided into a plurality of sub-fields on a time base, and respective luminance weights are set for the plurality of sub-fields.

For example, one field is divided into ten sub-fields (hereinafter referred to as a first SF, a second SF, . . . and a tenth SF) on the time base, and the sub-fields have the luminance weights of 1, 2, 3, 6, 11, 18, 30, 44, 60 and 81, respectively.

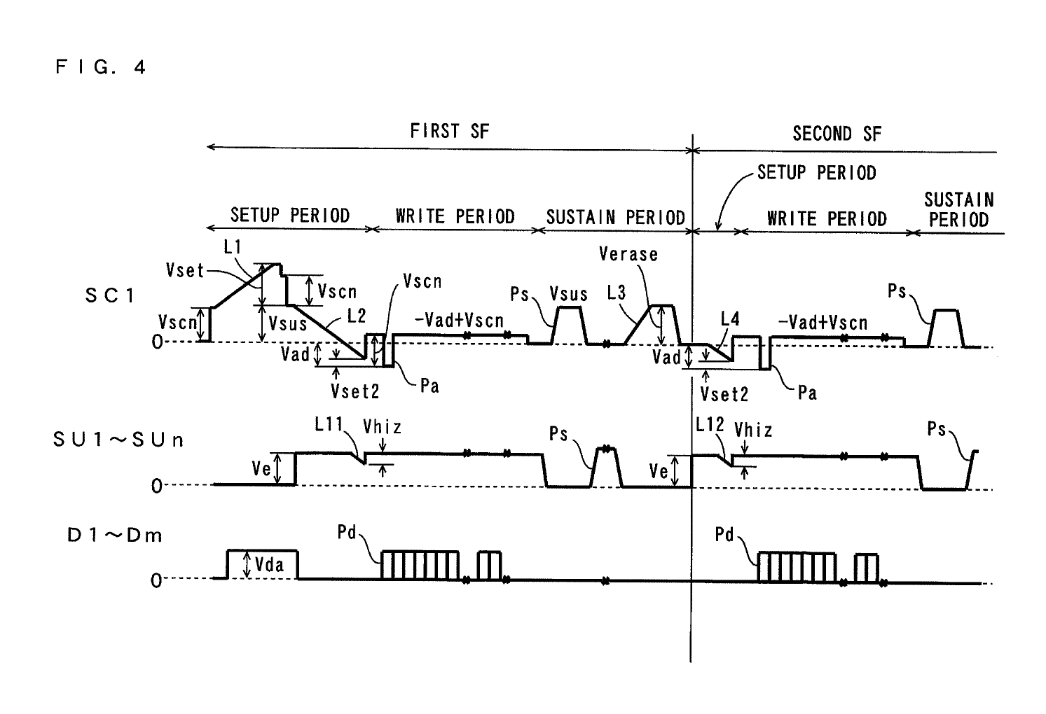

FIG. 4 is a driving waveform diagram in the sub-field configuration of the plasma display apparatus of FIG. 3. FIG. 4 shows the driving waveforms of the one scan electrode SC1, the sustain electrodes SU1 to SUn, and the data electrodes D1 to Dm. A period from a setup period of the first SF to a sustain period of the second SF in one field is shown in FIG. 4.

In the first half of the setup period of the first SF, the potential of the data electrodes D1 to Dm are held at Vda, the sustain electrodes SU1 to SUn are held at 0 V (a ground potential), and a ramp waveform L1 is applied to each of the scan electrodes SC1 to SCn as shown in FIG. 4.

The ramp waveform L1 gradually rises from a positive potential Vscn that is not more than a discharge start voltage toward a positive potential (Vsus+Vset) that exceeds the discharge start voltage. Then, first weak setup discharges are induced in all the discharge cells, so that negative wall charges are stored on the scan electrodes SC1 to SCn while positive wall charges are stored on the sustain electrodes SU1 to SUn and the data electrodes D1 to Dm, respectively. Here, a voltage caused by wall charges stored on the dielectric layer, the phosphor layer and so on covering the electrode is referred to as a wall voltage on the electrode.

In the subsequent second half of the setup period, the data electrodes D1 to Dm are held at the ground potential, the sustain electrodes SU1 to SUn are held at a positive potential Ve, and a ramp waveform L2 that gradually drops from the positive potential (Vsus) toward a negative potential (−Vad+Vset2) is applied to the scan electrodes SC1 to SCn. Then, second weak setup discharges are induced in all the discharge cells, so that the wall voltage on the scan electrode SCi and the wall voltage on the sustain electrode SUi are weakened, and the wall voltage on the data electrode Dk is adjusted to a value suitable for a write operation in all the discharge cells.

A ramp waveform L11 that gradually drops from a potential Ve to a potential (Ve−Vhiz) is applied to the sustain electrodes SU1 to SUn at a given timing during the application of the ramp waveform L2 to the scan electrodes SC1 to SCn. Thus, a potential difference between the scan electrodes SC1 to SCn and the sustain electrodes SU1 to SUn temporarily becomes constant, and discharges are not generated between the scan electrodes SC1 to SCn and the sustain electrodes SU1 to SUn.

The sustain electrodes SU1 to SUn are disconnected from a power supply terminal and a ground terminal to be brought into a floating state, thereby forming the above-mentioned ramp waveform L11 and a ramp waveform L12, which will be described below. Details will be described below.

As described above, a setup operation for all cells in which the setup discharges are generated in all the discharge cells is performed in the setup period of the first SF.

In a write period of the first SF, the sustain electrodes SU1 to SUn are held at the potential Ve, and the scan electrodes SC1 to SCn are temporarily held at the potential (−Vad+Vscn). Next, a positive write pulse Pd (=Vda) is applied to a data electrode Dk (k is any of 1 to m), among the data electrodes D1 to Dm, of the discharge cell that should emit light on a first row while a negative scan pulse Pa (=−Vad) is applied to the scan electrode SC1 on the first row. Then, a voltage at an intersection of the data electrode Dk and the scan electrode SC1 attains a value obtained by adding the wall voltage on the data electrode Dk and the wall voltage on the scan electrode SC1 to an externally applied voltage (Pd−Pa), exceeding the discharge start voltage. This generates a write discharge between the data electrode Dk and the scan electrode SC1 and between the sustain electrode SU1 and the scan electrode SC1. As a result, in the discharge cell, the positive wall charges are stored on the scan electrode SC1, the negative wall charges are stored on the sustain electrode SU1 and the negative wall charges are stored on the data electrode Dk.

In this manner, the write operation for generating the write discharge in the discharge cell that should emit light on the first row to cause the wall charges to be stored on each of the electrodes is performed. On the other hand, since a voltage at an intersection of a data electrode Dh(h≠k) to which the write pulse Pd has not been applied and the scan electrode SC1 does not exceed the discharge start voltage, the write discharge is not generated. The above-described write operation is sequentially performed in the discharge cells on the first row to the n-th row, and the write period is then finished.

In a subsequent sustain period, the sustain electrodes SU1 to SUn are returned to the ground potential, and a sustain pulse Ps (=Vsus) is applied to the scan electrodes SC1 to SCn for the first time in the sustain period. At this time, in the discharge cell in which the write discharge has been generated in the write period, a voltage between the scan electrode SCi and the sustain electrode SUi attains a value obtained by adding the wall voltage on the scan electrode SCi and the wall voltage on the sustain electrode SUi to the sustain pulse Ps (=Vsus), exceeding the discharge start voltage. This induces a sustain discharge between the scan electrode SCi and the sustain electrode SUi, causing the discharge cell to emit light. As a result, the negative wall charges are stored on the scan electrode SCi, the positive wall charges are stored on the sustain electrode SUi, and the positive wall charges are stored on the data electrode Dk.

In the discharge cell in which the write discharge has not been generated in the write period, the sustain discharge is not induced and the wall charges are held in a state at the end of the setup period. Next, the scan electrodes SC1 to SCn are returned to the ground potential, and the sustain pulse Ps is applied to the sustain electrodes SU1 to SUn. Then, since the voltage between the sustain electrode SUi and the scan electrode SCi exceeds the discharge start voltage in the discharge cell in which the sustain discharge has been induced, the sustain discharge is again induced between the sustain electrode SUi and the scan electrode SCi, the negative wall charges are stored on the sustain electrode SUi, and the positive wall charges are stored on the scan electrode SCi.

Similarly to the foregoing, a predetermined number of sustain pulses Ps are alternately applied to the respective scan electrodes SC1 to SCn and sustain electrodes SU1 to SUn, so that the sustain discharges are continuously performed in the discharge cells in which the write discharges have been generated in the write period.

After the sustain pulse Ps is applied, a ramp waveform L3 is applied to the scan electrodes SC1 to SCn while the sustain electrodes SU1 to SUn and the data electrodes D1 to Dm are held at the ground potential. The ramp waveform L3 gradually rises from the ground potential toward a positive potential Verase. This causes the voltage between the scan electrode SCi and the sustain electrode SUi to exceed the discharge start voltage, so that a weak erase discharge is generated between the sustain electrode SUi and the scan electrode SCi in the discharge cell in which the sustain discharge has been induced.

As a result, the negative wall charges are stored on the scan electrode SCi and the positive wall charges are stored on the sustain electrode SUi. At this time, the positive wall charges are stored on the data electrode Dk. Then, the scan electrodes SC1 to SCn are returned to the ground potential and the sustain operation in the sustain period is finished.

In a setup period of the second SF, the sustain electrodes SU1 to SUn are held at the potential Ve, the data electrodes D1 to Dm are held at the ground potential, and a ramp waveform L4 that gradually drops from the ground potential toward the negative potential (−Vad+Vset2) is applied to the scan electrodes SC1 to SCn.

Then, the weak setup discharges are generated in the discharge cells in which the sustain discharges have been induced in the sustain period of the preceding sub-field (the first SF in FIG. 4).

Accordingly, the wall voltages on the scan electrode SCi and the sustain electrode SUi are weakened in the discharge cells in which the sustain discharges have been induced in the preceding sub-field, and the wall voltage on the data electrode Dk is also adjusted to the value suitable for the write operation.

Discharges are not generated and the wall charges are kept constant in the state at the end of the setup period of the preceding sub-field in the discharge cells in which the sustain discharges have not been induced in the preceding sub-field. In this manner, a selective setup operation for selectively generating the setup discharges in the discharge cells in which the sustain discharges have been induced in the immediately preceding sub-field is performed in the setup period of the second SF.

The ramp waveform L12 that gradually drops from the potential Ve to the potential (Ve−Vhiz) is applied to the sustain electrodes SU1 to SUn at a given timing during the application of the ramp waveform L4 to the scan electrodes SC1 to SCn. Thus, the potential difference between the scan electrodes SC1 to SCn and the sustain electrodes SU1 to SUn temporarily becomes constant, and discharge are not generated between the scan electrodes SC1 to SCn and the sustain electrodes SU1 to SUn.

In a write period of the second SF, the same driving waveforms as those in the write period of the first SF are applied to the scan electrodes SC1 to SCn, the sustain electrodes SU1 to SUn and the data electrodes D1 to Dm.

The predetermined number of sustain pulses Ps are alternately applied to the scan electrodes SC1 to SCn and the sustain electrodes SU1 to SUn in a sustain period of the second SF similarly to the sustain period of the first SF. Accordingly, the sustain discharges are performed in the discharge cells in which the write discharges have been generated in the write period.

The same driving waveforms as those in the second SF are applied to the scan electrodes SC1 to SCn, the sustain electrodes SU1 to SUn and the data electrodes D1 to Dm in the third SF and the subsequent SFs.

In the present embodiment, the value of the voltage Ve applied to the sustain electrodes SU1 to SUn is set to such a value that a good write operation is performed in the write period. In this case, if the potential of the sustain electrodes SU1 to SUn is held at Ve during the application of the ramp waveforms L2, L4 to the scan electrodes SC1 to SCn, the potential difference between the scan electrodes SC1 to SCn and the sustain electrodes SU1 to SUn becomes larger than necessary. This causes excessive discharges to be generated between the scan electrodes SC1 to SCn and the sustain electrodes SU1 to SUn.

Therefore, the ramp waveforms L11, L12 are applied to the sustain electrodes SU1 to SUn at the given timings in order to adjust an amount of electric charges generated by discharges between the scan electrodes SC1 to SCn and the sustain electrodes SU1 to SUn. In this case, the potential difference between the scan electrodes SC1 to SCn and the sustain electrodes SU1 to SUn is temporarily held constant. This prevents excessive discharges from being generated between the scan electrodes SC1 to SCn and the sustain electrodes SU1 to SUn.

However, the slope of each of the ramp waveforms L2, L4 applied to the scan electrodes SC1 to SCn tends to vary. This makes it difficult to accurately control the amount of electric charges generated by discharges between the scan electrodes SC1 to SCn and the sustain electrodes SU1 to SUn. Accordingly, the amount of wall charges on the scan electrodes SC1 to SCn or the sustain electrodes SU1 to SUn becomes excessive or insufficient when the write period is started. As a result, malfunctions such as erroneous discharges tend to occur in the write period and the sustain period.

In the present embodiment, the application timings of the ramp waveforms L11, L12 to the sustain electrodes SU1 to SUn are controlled based on change in the potential of the scan electrodes SC1 to SCn. This allows for accurate control of the amount of electric charges generated by discharges between the scan electrodes SC1 to SCn and the sustain electrodes SU1 to SUn. Details will be described below.

### (4) Scan Electrode Drive Circuit

### (4-1) Configuration of the Scan Electrode Drive Circuit

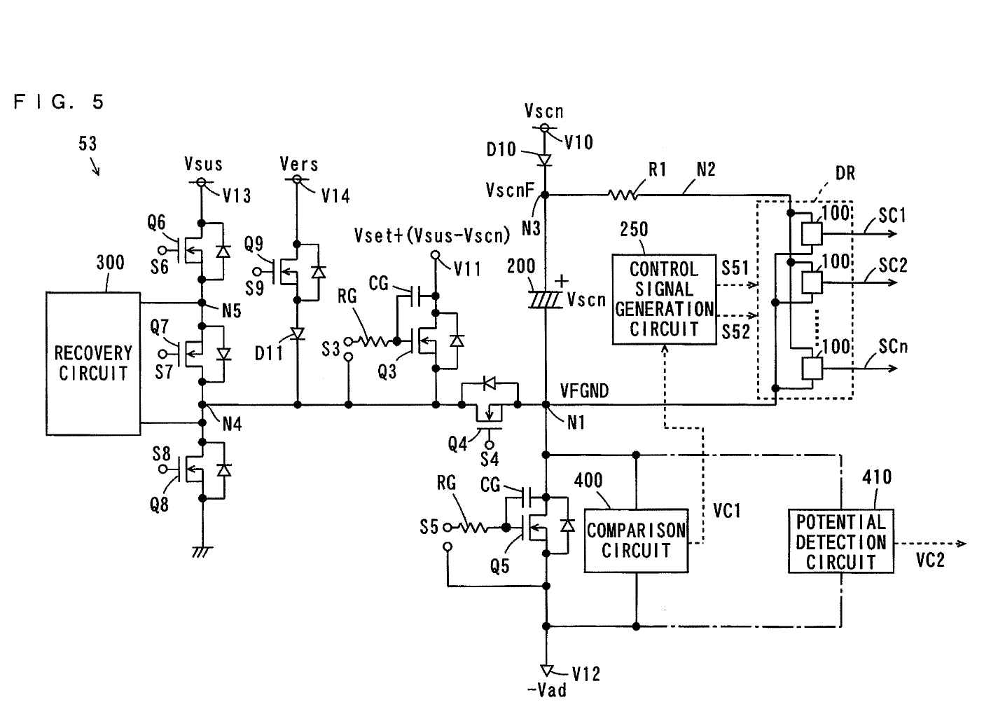

FIG. 5 is a circuit diagram showing the configuration of the scan electrode drive circuit 53. As shown in FIG. 5, the scan electrode drive circuit 53 includes a drive circuit DR, a DC power supply 200, a control signal generation circuit 250, a recovery circuit 300, a comparison circuit 400, diodes D10, D11 and n-channel field effect transistors (hereinafter abbreviated as transistors) Q3 to Q9.

The drive circuit DR includes a plurality of scan ICs 100. The scan ICs 100 are connected between a node N1 and a node N2, and connected to the scan electrodes SC1 to SCn, respectively. The scan ICs 100 selectively connect the corresponding scan electrodes SC1 to SCn to the node N1 and the node N2.

The control signal generation circuit 250 applies control signals S51, S52 to the drive circuit DR based on the timing signal applied from the timing generation circuit 55 of FIG. 3 and a potential switching signal VC1 applied from the comparison circuit 400 that will described below. Accordingly, the state of the scan ICs 100 is controlled. Details of the scan ICs 100 will be described below.

A power supply terminal V10 that receives the voltage Vscn is connected to a node N3 through the diode D10. The DC power supply 200 is connected between the node N1 and the node N3. The DC power supply 200 is composed of an electrolytic capacitor, and functions as a floating power supply that holds the voltage Vscn. A protective resistor R1 is connected between the node N2 and the node N3. Hereinafter, the potential of the node N1 is referred to as VFGND, and the potential of the node N3 is referred to as VscnF. The potential VscnF of the node N3 has a value obtained by adding the voltage Vscn to the potential VFGND of the node N1. That is, VscnF=VFGND+Vscn.

The transistor Q3 is connected between a power supply terminal V11 that receives a voltage (Vset+(Vsus−Vscn)) and a node N4, and provided with a control signal S3 at its gate. The transistor Q4 is connected between the node N1 and the node N4, and provided with a control signal S4 at its gate. The transistor Q5 is connected between the node N1 and a power supply terminal V12 that receives the negative voltage (−Vad), and provided with a control signal S5 at its gate. The control signal S4 is an inverted signal of the control signal S5.

A gate resistor RG and a capacitor CG are connected to the transistor Q3, and a gate resistor RG and a capacitor CG are connected to the transistor Q5. A gate resistor and a capacitor, not shown, are also connected to the transistor Q6.

The transistor Q6 is connected between a power supply terminal V13 that receives the voltage Vsus and a node N5. The transistor Q6 is provided with a control signal S6 at its base. The transistor Q7 is connected between the node N4 and the node N5, and provided with a control signal S7 at its gate. The transistor Q8 is connected between the node N4 and a ground terminal, and provided with a control signal S8 at its base.

The transistor Q9 and the diode D11 are connected between a power supply terminal V14 that receives a voltage Vers and the node N4. The transistor Q9 is provided with a control signal S9 at its base.

The recovery circuit 300 is connected between the node N4 and the node N5. The recovery circuit 300 recovers the electric charges from the plurality of discharge cells and stores the recovered electric charges, and provides the stored electric charges to the plurality of discharge cells in the sustain period.

The comparison circuit 400 is connected between the power supply terminal V12 and the node N1. The comparison circuit 400 generates the potential switching signal VC1 based on change in the potential of the node N1, and provides the potential switching signal VC1 to the control signal generation circuit 250.

The potential detection circuit 410 is connected between the power supply terminal V12 and the node N1. The potential detection circuit 410 generates the potential switching signal VC2 based on the change in the potential of the node N1.

Details of the comparison circuit 400 and the potential detection circuit 410 will be described below.

### (4-2) Details of the Scan ICs

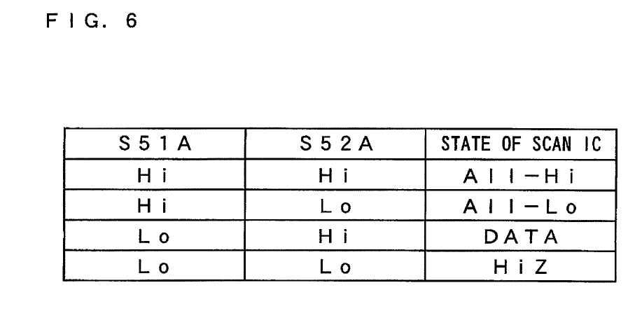

Description is made of details of the scan ICs 100. The state of the scan ICs 100 is switched depending on respective logic of the control signals S51, S52 output from the control signal generation circuit 250. FIG. 6 is a diagram showing correspondences among respective logic of the control signals S51, S52 and the state of the scan ICs.

As shown in FIG. 6, when both the control signals S51, S52 are at a high level (Hi), each scan IC 100 enters an “All-Hi” (all-high) state. All the scan ICs 100 connect the corresponding scan electrodes to the node N2 in the “All-Hi” state. That is, the potentials of the scan electrodes SC1 to SCn are equal to the potentials of the node N2 and the node N3.

When the control signals S51 is at a high level and the control signal S52 is at a low level (Lo), each scan IC 100 enters an “All-Lo” (all-low) state. All the scan ICs 100 connect the corresponding scan electrodes to the node N1 in the “All-Lo” state. That is, the potentials of the scan electrodes SC1 to SCn are equal to the potential of the node N1.

When the control signal S51 is at a low level and the control signal S52 is at a high level, each scan IC 100 enters a “DATA” (data) state. The scan ICs 100 sequentially connect the corresponding scan electrodes to the node N1 in the “DATA” state. In this case, the write pulse is sequentially applied to the scan electrodes SC1 to SCn in the write period.

When both the control signals S51, S52 are at a low level, each scan IC 100 enters a “HiZ” (high impedance) state. All the scan ICs 100 disconnect the corresponding scan electrodes from the node N1 and the node N2 in the “Hiz” state.

### (4-3) Operation of the Scan Electrode Drive Circuit

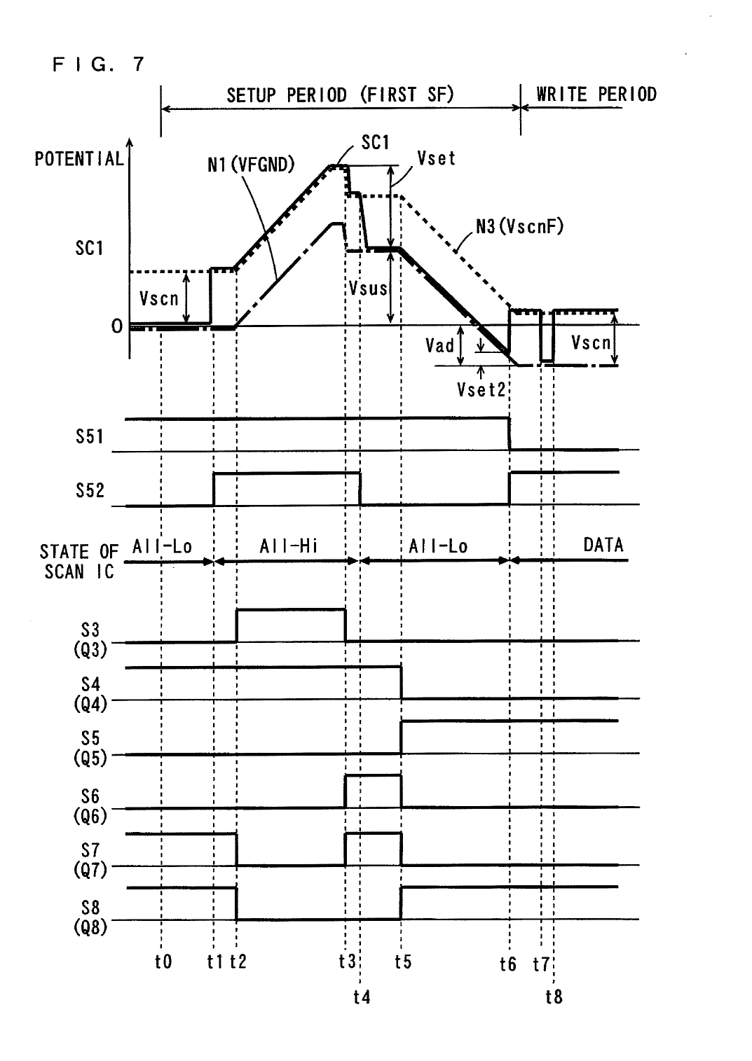

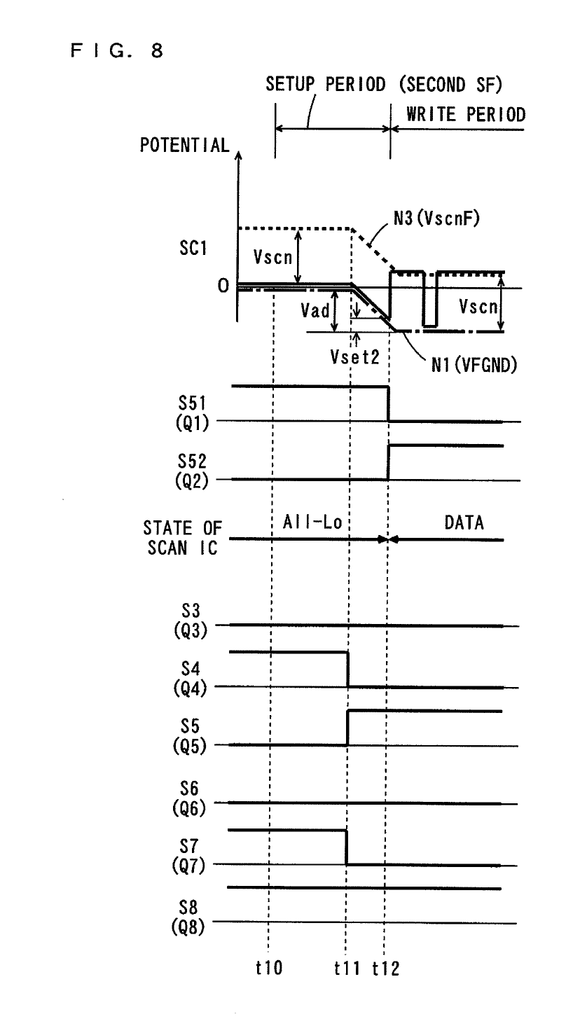

Description is made of operation of the scan electrode drive circuit 53. FIGS. 7 and 8 are timing charts of the control signals applied to the scan electrode drive circuit 53. FIG. 7 is the timing chart of the control signals in the setup period and the write period of the first SF, and FIG. 8 is the timing chart of the control signals in the setup period and the write period of the second SF.

Change in the potential VFGND of the node N1 is indicated by the one-dot and dash line, change in the potential VscnF of the node N3 is indicated by the dotted line, and change in the potential of the scan electrode SC1 is indicated by the solid line in top stages of FIGS. 7 and 8.

As shown in FIG. 7, the control signal S51 attains a high level and the control signal S52 attain a low level at a starting time point t0 of the setup period in the first SF. This causes the scan ICs 100 to be in the “All-Lo” state. The control signals S3, S5, S6 attain a low level, and the control signals S4, S7, S8 attain a high level. Thus, the transistors Q3, Q5, Q6 are turned off and the transistors Q4, Q7, Q8 are turned on.

Accordingly, the node N1 attains the ground potential (0 V) and the potential VscnF of the node N3 attains Vscn. Since the scan ICs 100 are in the “All-Lo” state, the potential of the scan electrode SC1 attains the ground potential.

The control signal S52 attains a high level at a time point t1. Thus, the scan ICs 100 are in the “All-Hi” state. This causes the potential of the scan electrode SC1 to rise to Vscn.

The control signal S3 attains a high level, and the control signals S7, S8 attain a low level at a time point t2. Thus, the transistor Q3 is turned on and the transistors Q7, Q8 are turned off. Thus, an RC integration circuit constituted by the gate resistor RG and the capacitor CG connected to the transistor Q3 causes the potential VFGND of the node N1 to gradually rise to (Vset+(Vsus−Vscn)). The potential VscnF of the node N3 gradually rises to (Vsus+Vset). At this time, since the scan ICs 100 are in the “All-Hi” state, the potential of the scan electrode SC1 gradually rises to (Vsus+Vset).

The control signal S3 attains a low level, and the control signals S6, S7 attain a high level at a time point t3. Thus, the transistor Q3 is turned off, and the transistors Q6, Q7 are turned on. As a result, the potential VFGND of the node N1 drops to Vsus, and the potential VscnF of the node N3 drops to (Vscn+Vsus). At this time, since the scan ICs 100 are in the “All-Hi” state, the potential of the scan electrode SC1 drops to (Vscn+Vsus).

The control signal S52 attains a low level at a time point t4. Thus, the scan ICs 100 enter the “All-Lo” state. At this time, since the potential of the potential VFGND of the node N1 attains Vsus, the potential of the scan electrode SC1 drops to Vsus.

The control signals S4, S6, S7 attain a low level, and the control signals S5, S8 attain a high level at a time point t5. Thus, the transistors Q4, Q6, Q7 are turned off, and the transistors Q5, Q8 are turned on. As a result, an RC integration circuit constituted by the gate resistor RG and the capacitor CG connected to the transistor Q5 causes the potential VFGND of the node N1 to gradually drop toward (−Vad). At this time, since the scan ICs 100 are in the “All-Lo” state, the potential of the scan electrode SC1 gradually drops toward (−Vad). The control signal S51 attains a low level, and the control signal S52 attains a high level at a time point t6 where the potential of the scan electrode SC1 (the potential of the node N1) attains (−Vad+Vset2). This causes the scan ICs 100 to enter the “DATA” state. As a result, the potential of the scan electrode SC1 rises to (−Vad+Vscn).

In the write period, the scan ICs 100 are maintained in the “DATA” state. Thus, the scan electrodes SC1 to SCn are sequentially connected to the node N1. At this time, the potential VFGND of the node N1 attains (−Vad). Therefore, the potential of the scan electrodes SC1 to SCn sequentially drops to (−Vad). In FIG. 7, the potential of the scan electrode SC1 drops to (−Vad) in a period between a time point t7 and a time point t8.

As shown in FIG. 8, the control signal S51 attains a high level, and the control signal S52 attains a low level at a starting time point t10 of the setup period in the second SF. Thus, the scan ICs 100 enter the “All-Lo” state. The control signals S3, S5, S6 attain a low level, and the control signals S4, S7, S8 attain a high level. Thus, the transistors Q3, Q5, Q6 are turned off, and the transistors Q4, Q7, Q8 are turned on.

Accordingly, the potential VFGND of the node N1 attains the ground potential, and the potential VscnF of the node N3 attains Vscn. Since the scan ICs 100 are in the “All-Lo” state, the potential of the scan electrode SC1 attains the ground potential.

The control signals S4, S7 attain a low level, and the control signal S5 attains a high level at a time point t11. Thus, the transistors Q4, Q7 are turned off, and the transistor Q5 is turned on. As a result, the RC integration circuit constituted by the gate resistor RG and the capacitor CG connected to the transistor Q5 causes the potential VFGND of the node N1 to gradually drop toward (−Vad). At this time, since the scan ICs 100 are in the “All-Lo” state, the potential of the scan electrode SC1 gradually drops toward (−Vad).

The control signal S51 attains a low level, and the control signal S52 attains a high level at a time point t12 where the potential of the scan electrode SC1 (the potential of the node N1) attains (−Vad+Vset2). Thus, the scan ICs 100 enter the “DATA” state. As a result, the potential of the scan electrode SC1 rises to (−Vad+Vscn).

Each of the control signals changes in the write period in the same manner as in the write period of the first SF. Each of the control signals changes in the third SF and the subsequent SFs in the same manner as in the second SF.

### (5) The Sustain Electrode Drive Circuit

### (5-1) Configuration of the Sustain Electrode Drive Circuit

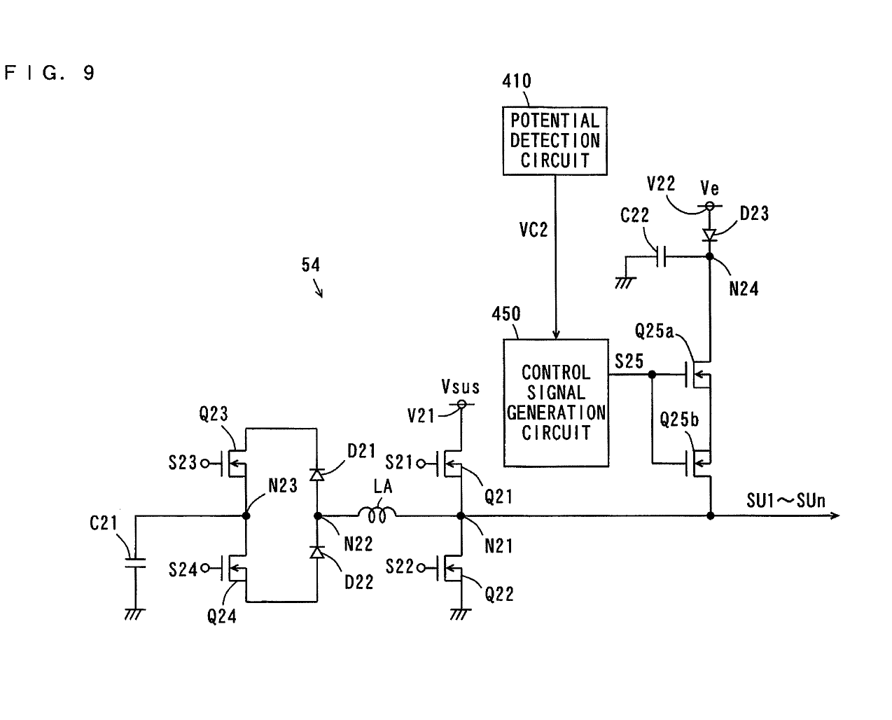

FIG. 9 is a circuit diagram showing the configuration of the sustain electrode drive circuit 54. As shown in FIG. 9, the sustain electrode drive circuit 54 includes n-channel field effect transistors (hereinafter abbreviated as transistors) Q21 to Q24, Q25a, Q25b, diodes D21 to D23, a recovery coil LA, capacitors C21, C22 and a control signal generation circuit 450.

The transistor Q21 is connected between a power supply terminal V21 and a node N21, and provided with a control signal S21 at its gate. The voltage Vsus is applied to the power supply terminal V21. The node N21 is connected to the sustain electrodes SU1 to SUn.

The transistor Q22 is connected between the node N21 and the ground terminal, and provided with a control signal S22 at its gate. The recovery coil LA is connected between the node N21 and a node N22.

Between the node N22 and a node N23, the diode D21 and the transistor Q23 are connected in series, and the diode D22 and the transistor Q23 are connected in series. The transistor Q23 is provided with a control signal S23 at its gate, and the transistor Q24 is provided with a control signal S24 at its gate. The capacitor C21 is connected between the node N23 and the ground terminal.

The transistors Q25a, Q25b are connected in series between the node N21 and a node N24. Each of the transistors Q25a, Q25b is provided with a common control signal S25 at its gate from the control signal generation circuit 450. The control signal generation circuit 450 controls ON/OFF of the transistors Q25a, Q25b.

The potential detection circuit 410 is connected to the control signal generation circuit 450. The control signal generation circuit 450 is provided with the potential switching signal VC2 from the potential detection circuit 410. Details will be described below. The capacitor C22 is connected between the node N24 and the ground terminal. The diode D23 is connected between a power supply terminal V22 and the node N24. The voltage Ve is applied to the power supply terminal V22.

### (5-2) Operation of the Sustain Electrode Drive Circuit

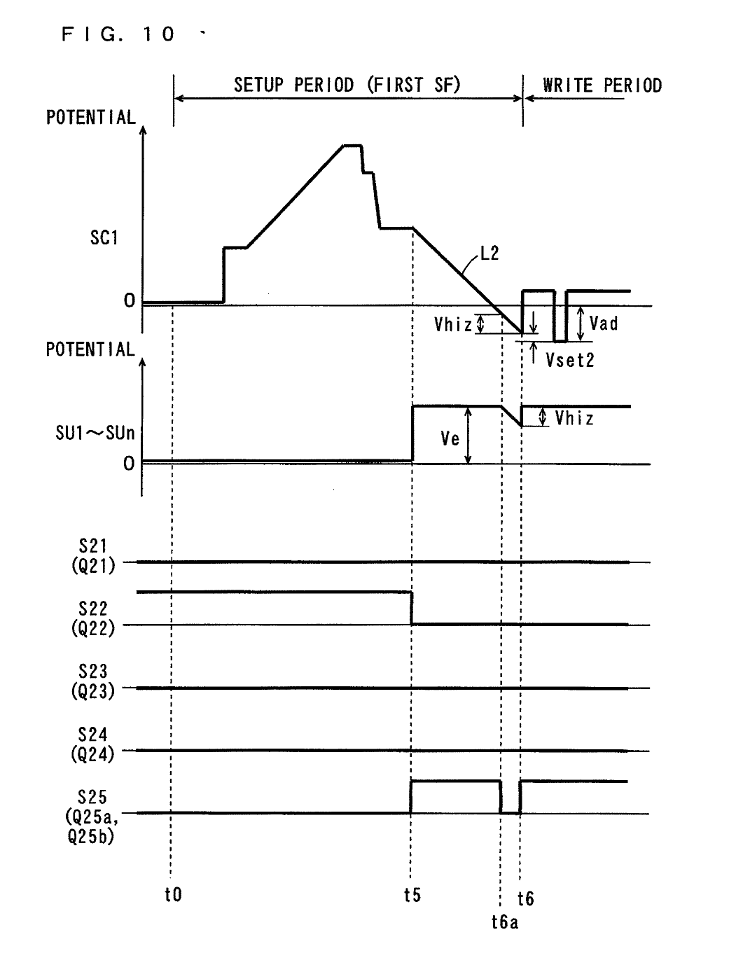

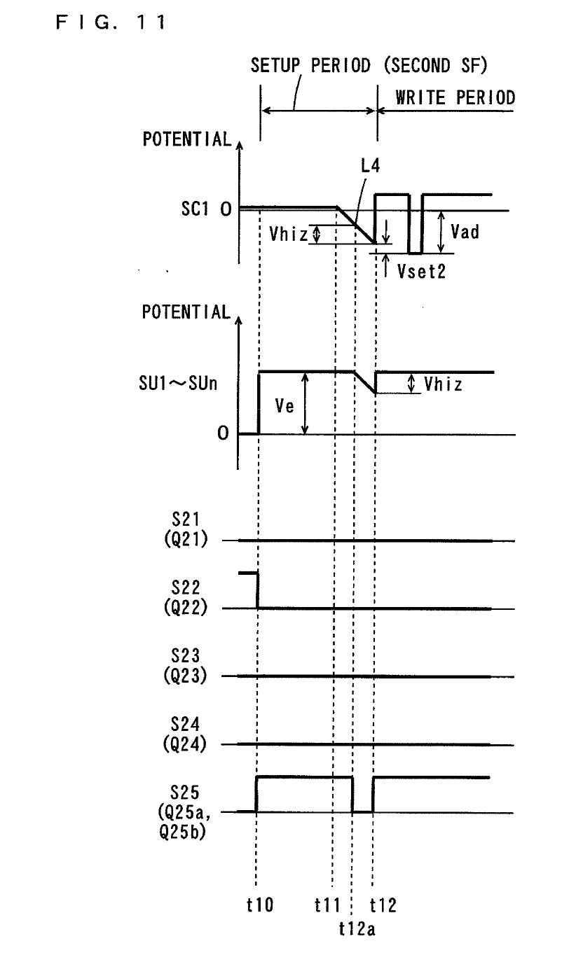

Description is made of operation of the sustain electrode drive circuit 54. FIGS. 10 and 11 are timing charts of the control signals applied to the sustain electrode drive circuit 54. FIG. 10 is the timing chart of the control signals in the setup period and the write period of the first SF, and FIG. 11 is the timing chart of the control signals in the setup period and the write period of the second SF.

For reference, top stages of FIGS. 10 and 11 each show the change in the potential of the scan electrode SC1 shown in FIGS. 7 and 8. Change in the potential of the sustain electrodes SU1 to SUn is shown in a lower stage.

As shown in FIG. 10, the control signals S21, S23, S24, S25 attain a low level, and the control signal S22 attains a high level at the starting time point t0 of the setup period in the first SF. Thus, the transistors Q21, Q23, Q24, Q25a, Q25b are turned off, and the transistor Q22 is turned on. Therefore, the node N21 attains the ground potential, and the potential of the sustain electrodes SU1 to SUn attain the ground potential.

The control signal S22 attains a low level, and the control signal S25 attains a high level at the time point t5 where the potential of the scan electrode SC1 starts to drop. Thus, the transistor Q22 is turned off, and the transistors Q25a, Q25b are turned on. As a result, the potential of the sustain electrodes SU1 to SUn rises to Ve.

The control signal S25 attains a low level, and the transistors Q25a, Q25b are turned off at a time point t6a where the potential of the scan electrode SC1 attains (−Vad+Vset2+Vhiz). In this case, the sustain electrodes SU1 to SUn are brought into a state of being disconnected from any of the power supply terminal and the ground terminal (the floating state). Therefore, the potential of the sustain electrodes SU1 to SUn changes according to the change in the potential of the scan electrodes SC1 to SCn due to capacitive coupling. That is, the potential of the sustain electrodes SU1 to SUn gradually drops from the potential Ve, and the potential difference between the scan electrodes SC1 to SCn and the sustain electrodes SU1 to SUn is held substantially constant.

At the time point t6a, ON/OFF of the transistors Q25a, Q25b is switched based on the potential switching signal VC2 output from the potential detection circuit 410. Details of the potential detection circuit 410 and the potential switching signal VC2 will be described below.

At the time point t6, the control signal S25 attains a high level. This causes the transistors Q25a, Q25b to be turned on. As a result, the potential of the sustain electrodes SU1 to SUn rises to Ve. The potential of the sustain electrodes SU1 to SUn is held at Ve in the write period.

As shown in FIG. 11, the control signals S21 to S24 attain a low level, and the control signal S25 attains a high level at the starting time point t10 of the setup period in the second SF. Therefore, the transistors Q21 to Q24 are turned off, and the transistors Q25a, Q25b are turned on. This causes the potential of the sustain electrodes SU1 to SUn to be held at Ve.

The potential of the scan electrode SC1 starts to drop at the time point t11, and the control signal S25 attains a low level at a time point t12a where the potential of the scan electrode SC1 attains (−Vad+Vset2+Vhiz). This causes the transistors Q25a, Q25b to be turned off. In this case, the sustain electrodes SU1 to SUn are brought into the state of being disconnected from any of the power supply terminal and the ground terminal (the floating state). Therefore, the potential of the sustain electrodes SU1 to SUn changes according to the change in the potential of the scan electrodes SC1 to SCn due to capacitive coupling. That is, the potential of the sustain electrodes SU1 to SUn gradually drops from the potential Ve, and the potential difference between the scan electrodes SC1 to SCn and the sustain electrodes SU1 to SUn is held substantially constant.

Similarly to the operation at the time point t6a, ON/OFF of the transistors Q25a, Q25b is switched based on the potential switching signal VC2 output from the potential detection circuit 410 at the time point t12a.

The control signal S25 attains a high level at the time point t12. This causes the transistors Q25a, Q25b to be turned on. As a result, the potential of the sustain electrodes SU1 to SUn rises to Ve. The potential of the sustain electrodes SU1 to SUn is held at Ve in the write period.

### (6) Details of the Comparison Circuit and the Potential Detection Circuit

### (6-1) Configurations of the Comparison Circuit and the Potential Detection Circuit

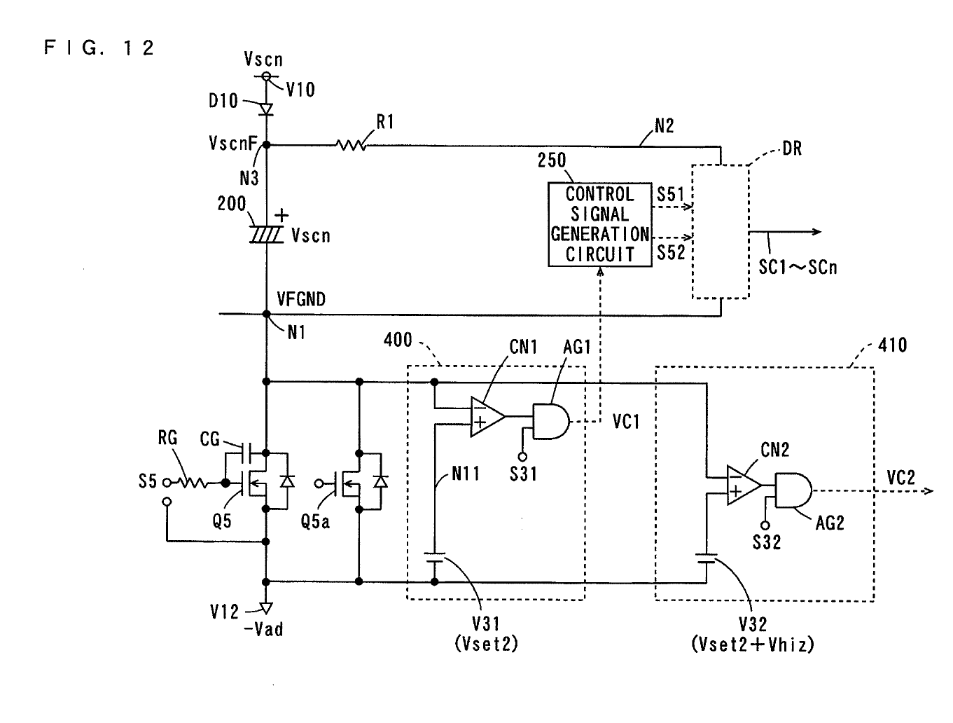

Description is made of details of the comparison circuit 400 and the potential detection circuit 410 in the scan electrode drive circuit 53. FIG. 12 is a circuit diagram specifically showing the configurations of the comparison circuit 400, the potential detection circuit 410 and peripheral portions thereof.

As shown in FIG. 12, the comparison circuit 400 includes a comparator CN1, an AND gate circuit AG1 and a power supply V31. A negative-side input terminal of the comparator CN1 is connected to the node N1. A positive-side input terminal of the comparator CN1 is connected to the power supply terminal V12 through the power supply V31. The power supply V31 holds the voltage Vset2. This causes the potential of the positive-side input terminal of the comparator CN1 to be held at (−Vad+Vset2).

An output terminal of the comparator CN1 is connected to one input terminal of the AND gate circuit AG1. The AND gate circuit AG1 is provided with a control signal S31 at the other input terminal thereof. The potential switching signal VC1 is output from an output terminal of the AND gate circuit AG1 to be applied to the control signal generation circuit 250.

The potential detection circuit 410 includes a comparator CN2, an AND gate circuit AG2 and a power supply V32. A negative-side input terminal of the comparator CN2 is connected to the node N1. A positive-side input terminal of the comparator CN2 is connected to a power supply terminal V12 through the power supply V32. The power supply V32 holds the voltage (Vset2+Vhiz). This causes the potential of the positive-side input terminal of the comparator CN2 to be held at (−Vad+Vset2+Vhiz).

An output terminal of the comparator CN2 is connected to one input terminal of the AND gate circuit AG2. The AND gate circuit AG2 is provided with a control signal S32 at the other input terminal thereof. The potential switching signal VC2 is output from an output terminal of the AND gate circuit AG2 to be applied to the control signal generation circuit 450 in the sustain electrode drive circuit 54 of FIG. 9.

In the example of FIG. 12, an n-channel field effect transistor (hereinafter abbreviated as a transistor) Q5a is connected between the node N1 and the power supply terminal V12. The transistor Q5a is turned on while the transistor Q5 is turned off, so that the potential of the node N1 instantaneously drops to −Vad.

### (6-2) The Potential Switching Signals

When the ramp waveforms L2, L4 are applied to the scan electrodes SC1 to SCn, the scan ICs 100 of the scan electrode drive circuit 53 are controlled based on the potential switching signal VC1, and the transistors Q25a, Q25b of the sustain electrode drive circuit 54 are controlled based on the potential switching signal VC2. Specific description is made of changes of the potential switching signals VC1, VC2.

The ramp waveform L2 is applied to the scan electrodes SC1 to SCn in a period between the time point t5 and the time point t6 of FIG. 10. In this case, the potential of the node N1 of the scan electrode drive circuit 53 is higher than (−Vad+Vset2+Vhiz) in a period between the time point t5 and the time point t6a.

Therefore, the potential of the negative-side input terminal of the comparator CN1 is higher than the potential of the positive-side input terminal thereof, and the potential of the output terminal attains a low level in the comparison circuit 400 of FIG. 12. This causes the potential switching signal VC1 output from the AND gate circuit AG1 to attain a low level. In this case, the control signal generation circuit 250 maintains the control signal S51 at a high level and the control signal S52 at a low level.

Similarly, the potential of the negative-side input terminal of the comparator CN2 is higher than the potential of the positive-side input terminal thereof, and the potential of the output terminal attains a low level in the potential detection circuit 410. This causes the potential switching signal VC2 output from the AND gate circuit AG2 to attain a low level. In this case, the control signal generation circuit 450 in the sustain electrode drive circuit 54 maintains the control signal S25 at a high level.

When the potential of the node N1 attains (−Vad+Vset2+Vhiz) at the time point t6a, the potential of the output terminal of the comparator CN2 attains a high level in the potential detection circuit 410. In this case, the control signal S32 is maintained at a high level. Accordingly, the potential switching signal VC2 output from the output terminal of the AND gate circuit AG2 to attain a high level.

The control signal generation circuit 450 in the sustain electrode drive circuit 54 causes the control signal S25 to attain a low level according to change of the potential switching signal

VC2 at the time point t6a. Thus, the transistors Q25a, Q25b are turned off, and the sustain electrodes SU1 to SUn are brought into the floating state. As a result, the potential of the sustain electrodes SU1 to SUn drops together with the potential of the scan electrodes SC1 to SCn.

When the potential of the node N1 attains (−Vad+Vset2) at the time point t6, the potential of the output terminal of the comparator CN1 attains a high level in the comparison circuit 400. In this case, the control signal S31 is maintained at a high level. Accordingly, the potential switching signal VC1 output from the AND gate circuit AG1 attains a high level.

The control signal generation circuit 250 in the scan electrode drive circuit 53 causes the control signal S51 to attain a low level and the control signal S52 to attain a high level according to the change of the potential switching signal VC1 at the time point t6. This causes the scan ICs 100 to enter the “DATA” state. As a result, the potential of the scan electrode SC1 rises to (−Vad+Vscn). At this time, the potential of the sustain electrodes SU1 to SUn rises to Ve.

The ramp waveform L4 is applied to the scan electrodes SC1 to SCn in a period between the time point t11 and the time point t12 of FIG. 11. In this case, the potential of the node N1 of the scan electrode drive circuit 53 is higher than (−Vad+Vset2+Vhiz) in a period between the time point t11 and the time point t12a.

Therefore, the potential of the negative-side input terminal of the comparator CN1 is higher than the potential of the positive-side input terminal thereof, and the potential of the output terminal attains a low level in the comparison circuit 400. This causes the potential switching signal VC1 output from the AND gate circuit AG1 to attain a low level. In this case, the control signal generation circuit 250 maintains the control signal S51 at a high level and the control signal S52 at a low level.

Similarly, the potential of the negative-side input terminal of the comparator CN2 is higher than the potential of the positive-side input terminal thereof, and the potential of the output terminal attains a low level in the potential detection circuit 410. Thus, the potential of the output terminal of the AND gate circuit AG2 attains a low level, and the potential switching signal VC2 attains a low level. In this case, the control signal generation circuit 450 maintains the control signal S25 at a high level.

When the potential of the node N1 attains (−Vad+Vset2+Vhiz) at the time point t12a, the potential of the output terminal of the comparator CN2 attains a high level in the potential detection circuit 410. In this case, the control signal S32 is maintained at a high level. This causes the potential switching signal VC2 output from the AND gate circuit AG2 to attain a high level.

The control signal generation circuit 450 in the sustain electrode drive circuit 54 causes the control signal S25 to attain a low level according to the change of the potential switching signal VC2 at the time point t12a. Thus, the transistors Q25a, Q25b are turned off, and the sustain electrodes SU1 to SUn are brought into the floating state. As a result, the potential of the sustain electrodes SU1 to SUn drops together with the potential of the scan electrodes SC1 to SCn.

When the potential of the node N1 attains (−Vad+Vset2) at the time point t12, the potential of the output terminal of the comparator CN1 attains a high level in the comparison circuit 400. In this case, the control signal S31 is maintained at a high level. Thus, the potential switching signal VC1 output from the AND gate circuit AG1 attains a high level.

The control signal generation circuit 250 in the scan electrode drive circuit 53 causes the control signal S51 to attain a low level and the control signal S52 to attain a high level according to the change of the potential switching signal VC1 at the time point t12. Thus, the scan ICs 100 enter the “DATA” state. As a result, the potential of the scan electrode SC1 rises to (−Vad+Vscn). At this time, the potential of the sustain electrodes SU1 to SUn rises to Ve.

In this manner, the potential switching signals VC1, VC2 change based on the change in the potential of the node N1 of the scan electrode drive circuit 53, and the state of the scan ICs 100 and ON/OFF of the transistors Q25a, Q25b are controlled according to the changes of the potential switching signals VC1, VC2.

### (7) Effects of the Embodiment

In the present embodiment, the sustain electrodes SU1 to SUn are temporarily brought into the floating state during the application of the ramp waveforms L2, L4 to the scan electrodes SC1 to SCn. In the periods, discharges are not generated between the scan electrodes SC1 to SCn and the sustain electrodes SU1 to SUn. This allows the amount of electric charges generated by discharges between the scan electrodes SC1 to SCn and the sustain electrodes SU1 to SUn in the setup period to be optionally adjusted.

The timings at which the sustain electrodes SU1 to SUn are brought into the floating state are controlled based on the change in the potential of the scan electrodes SC1 to SCn. This allows the amount of electric charges generated by discharges between the scan electrodes SC1 to SCn and the sustain electrodes SU1 to SUn to be accurately controlled even though the slope of each of the ramp waveforms L2, L4 varies. Accordingly, a sufficient margin for generating good discharges can be ensured in the write period and the sustain period. As a result, malfunctions such as erroneous discharges can be reliably prevented from occurring.

A threshold value of the potential of the scan electrodes SC1 to SCn for bringing the sustain electrodes SU1 to SUn into the floating state (−Vad+Vset2+Vhiz in this example) is suitably set by means of repetitive experiments, various types of calculation, for example.

In the present embodiment, in the setup period, the potential of the sustain electrodes SU1 to SUn is held at Ve before the sustain electrodes SU1 to SUn are brought into the floating state, that is, when discharges are generated between the scan electrodes SC1 to SCn and the sustain electrodes SU1 to SUn. In this case, the potential of the sustain electrodes SU1 to SUn can be held using the common power supply terminal V22 in the setup period and the write period. This allows for the simplified configuration of the sustain electrode drive circuit 54 and cost reduction.

### (8) Other Embodiments

While the timings at which the sustain electrodes SU1 to SUn are brought into the floating state are controlled based on the potential switching signal VC2 applied from the potential detection circuit 410 to the sustain electrode drive circuit 54 in the above-described embodiment, another method may be employed for controlling the timings.

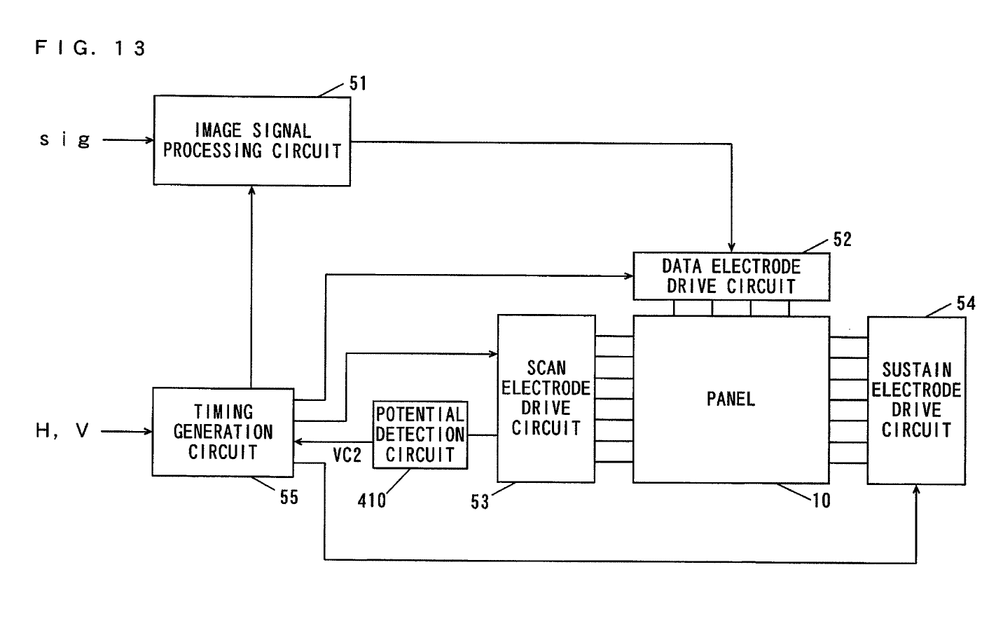

FIG. 13 is a block diagram of circuits showing another configuration of the plasma display apparatus. The potential detection circuit 410 applies the potential switching signal VC2 to the timing generation circuit 55 in the example of FIG. 13. The timing generation circuit 55 generates the timing signal based on the potential switching signal VC2 and applies the timing signal to the sustain electrode drive circuit 54. Thus, the timings at which the sustain electrodes SU1 to SUn are brought into the floating state are controlled.

Also in this case, the timings at which the sustain electrodes SU1 to SUn are brought into the floating state can be accurately controlled. This allows the amount of electric charges generated by discharges between the scan electrodes SC1 to SCn and the sustain electrodes SU1 to SUn to be accurately controlled.

While the ramp waveforms L11, L12 are applied to the sustain electrodes SU1 to SUn by bringing the sustain electrodes SU1 to SUn into the high impedance state in the above-described embodiment, the present invention is not limited to this. For example, a circuit (an integration circuit, for example) that forms the ramp waveforms L11, L12 may be provided in the sustain electrode drive circuit 54.

While the setup operation for all cells is performed in the first SF in the above-described embodiment, the selective setup operation may be performed in the first SF and the setup operation for all cells may be performed in any of the second SF and the subsequent SFs.

### (9) Correspondences Between Elements in the Claims and Parts in Embodiments

In the following paragraph, non-limiting examples of correspondences between various elements recited in the claims below and those described above with respect to various preferred embodiments of the present invention are explained.

In the foregoing embodiments, the period between the time point t5 and the time point t6 or the period between the time point t11 and the time point t12 is an example of a first period, Vsus or the ground potential is an example of a first potential, (−Vad+Vset2) is an example of a second potential, and the ramp waveforms L2, L4 are examples of a first ramp waveform. The potential switching signal VC2 is an example of a switching signal, (−Vad+Vset2+Vhiz) is an example of a third potential, Ve is an example of a fourth potential, (Ve−Vhiz) is an example of a fifth potential, and the ramp waveforms L11, L12 are examples of a second ramp waveform.

As each of various elements recited in the claims, various other elements having configurations or functions described in the claims can be also used.

### INDUSTRIAL APPLICABILITY

The present invention is applicable to a display apparatus that displays various images.

1. A driving device of a plasma display panel that drives the plasma display panel having a plurality of discharge cells at intersections of a plurality of scan electrodes and a plurality of sustain electrodes with a plurality of data electrodes by a sub-field method in which one field includes a plurality of sub-fields, comprising:
a scan electrode drive circuit that drives said plurality of scan electrodes;
a sustain electrode drive circuit that drives said plurality of sustain electrodes; and
a potential detection circuit, wherein
said scan electrode drive circuit applies a first ramp waveform that drops from a first potential to a second potential to said plurality of scan electrodes in a first period in a setup period of at least one sub-field of said plurality of sub-fields,
said potential detection circuit detects that said plurality of scan electrodes attain a third potential that is lower than said first potential and higher than said second potential in said first period, and
said sustain electrode drive circuit applies a second ramp waveform that drops from a fourth potential to a fifth potential to said plurality of sustain electrodes in response to detection of said third potential by said potential detection circuit.

2. The driving device of the plasma display panel according to claim 1, wherein said sustain electrode drive circuit brings said plurality of sustain electrodes into a floating state in response to the detection of said third potential by said potential detection circuit.

3. The driving device of the plasma display panel according to claim 1, wherein
said potential detection circuit generates a switching signal in a period, in which a potential of said plurality of scan electrodes drops from said third potential to said second potential, in said first period, and
said sustain electrode drive circuit applies said second ramp waveform to said plurality of sustain electrodes in the period in which said switching signal is generated.

4. The driving device of the plasma display panel according to claim 1, wherein said sustain electrode drive circuit holds said plurality of sustain electrodes at said fourth potential in a write period of the at least one sub-field of said plurality of sub-fields.

5. A driving method of a plasma display panel that drives the plasma display panel having a plurality of discharge cells at intersections of a plurality of scan electrodes and a plurality of sustain electrodes with a plurality of data electrodes by a sub-field method in which one field includes a plurality of sub-fields, comprising the steps of:
applying a first ramp waveform that drops from a first potential to a second potential to said plurality of scan electrodes in a first period in a setup period of at least one sub-field of said plurality of sub-fields,
detecting that said plurality of scan electrodes attain a third potential that is lower than said first potential and higher than said second potential in said first period, and
applying a second ramp waveform that drops from a fourth potential to a fifth potential to said plurality of sustain electrodes in response to detection of said third potential.

6. A plasma display apparatus comprising:
a plasma display panel having a plurality of discharge cells at intersections of a plurality of scan electrodes and a plurality of sustain electrodes with a plurality of data electrodes; and
a driving device that drives said plasma display panel by a sub-field method in which one field includes a plurality of sub-fields, wherein
said driving device includes:
a scan electrode drive circuit that drives said plurality of scan electrodes;
a sustain electrode drive circuit that drives said plurality of sustain electrodes; and
a potential detection circuit,
said scan electrode drive circuit applies a first ramp waveform that drops from a first potential to a second potential to said plurality of scan electrodes in a first period in a setup period of at least one sub-field of said plurality of sub-fields,
said potential detection circuit detects that said plurality of scan electrodes attain a third potential that is lower than said first potential and higher than said second potential in said first period, and
said sustain electrode drive circuit applies a second ramp waveform that drops from a fourth potential to a fifth potential to said plurality of sustain electrodes in response to detection of said third potential by said potential detection circuit.
